(19) United States
(12) Patent Application Publication
(10) Pub. No.: US 2013/0335437 A1
(43) Pub. Date: Dec. 19, 2013

(54) METHODS AND SYSTEMS FOR SIMULATING AREAS OF TEXTURE OF PHYSICAL PRODUCT ON ELECTRONIC DISPLAY

(71) Applicant: VISTAPRINT TECHNOLOGIES LIMITED, Hamilton (BM)

(72) Inventors: Zachary Ross Lynn, Lexington, MA (US); Eugene Hsu, Somerville, MA (US)

(73) Assignee: VISTAPRINT TECHNOLOGIES LIMITED, Hamilton (BM)

(21) Appl. No.: 13/973,396

(22) Filed: Aug. 22, 2013

Related U.S. Application Data
(63) Continuation-in-part of application No. 13/084,550, filed on Apr. 11, 2011.
Application No. 13/084,550 is a continuation-in-part of application No. 13/205,604, filed on Aug. 8, 2011.

(51) Int. Cl. G06T 13/80

(52) U.S. Cl. CPC G06T 13/80
USPC 345/589

(57) ABSTRACT

Design images are inserted into scene rendered animations to depict and preview a design at different lighting angles. In an embodiment, the scene rendered animations use real images (i.e., photographs) of real finishes (such as foil, spot gloss, vinyl, etc.) that will be used in the secondary finish regions of a physical product incorporating the design. The animation facilitates an accurate rendering and depicts a natural appearance of the product as light moves across the product in an animated sequence. Because the appearance of the secondary finish is both natural and accurate, the simulated depiction of the product provides a more realistic expectation of how the final product with the design implemented thereon will look, thereby improving the matching of user expectations with the realities of the physical product.

### PRIORITY CLAIM

This application is a continuation-in-part of, and claims priority to, U.S. application Ser. No. 13/084,550, filed Apr. 11, 2011 and U.S. application Ser. No. 13/205,604 filed Aug. 8, 2011, each of which is hereby incorporated by reference in its entirety.

### FIELD OF THE INVENTION

The present invention relates to the displaying of product images on an electronic display and, more particularly, to the displaying of images of products having areas of differing textures effecting visually distinguishable light reflection.

### BACKGROUND OF THE INVENTION

Printing services Web sites allowing a user to access the site from the user's home or work and design a personalized product are well known and widely used by many consumers, professionals, and businesses. For example, Vistaprint markets a variety of printed products, such as business cards, postcards, brochures, holiday cards, announcements, and invitations, online through the site www.vistaprint.com. Printing services web sites often allow the user to review thumbnail images of a number of customizable design templates prepared by the site operator having a variety of different styles, formats, backgrounds, color schemes, fonts and graphics from which the user may choose. When the user has selected a specific product design template to customize, the sites typically provide online tools allowing the user to incorporate the user's personal information and content into the selected template to create a custom design. When the design is completed to the user's satisfaction, the user can place an order through the web site for production and delivery of a desired quantity of a product incorporating the corresponding customized design.

Printing services sites strive to have the image of the product that is displayed to the customer on the customer's computer/electronic display be as accurate a representation as possible of the physical product that the user will later receive. Trying to simulate on the user's electronic display the visual effect of areas of different or non-standard texture that are especially distinguishable from the main printed surface at different angles of lighting has historically posed a problem.

These types of textured premium finishes that elicit differing lighting effects, including foil, gloss, raised print, embossment, vinyl, leather, cloth, and other textured finishes, which are to be applied in the creation of a finished product (such as a printed document) change in appearance depending on how light reflects off the premium finish surface. The appearance changes as either or both of the product itself or the illuminating light source moves.

The purpose of displaying a preview image of the product is to show the customer what the finished product will look like when manufactured. However, it has proven to be difficult to achieve a natural and accurate simulation of light over the surface of a premium finish to depict how the final product will appear when manufactured. In particular, premium finishes are very difficult to visualize in a static context because their effect is dependent on how light bounces off the finish surface. If upon delivery the delivered final product does not appear how the user imagined it would, this can lead to customer dissatisfaction.

U.S. Pat. No. 7,644,355, owned by the same assignee of interest of the present application and incorporated by reference herein in its entirety for all that it teaches, is directed to simulating the visual effect of light on shiny or reflective portions of a product surface, such as areas covered by foil. In the simulation image, foiled areas in a printed product are represented to a user viewing a product image by a looped animation comprising a sequence of images generated by applying a gradient function to an image of the areas corresponding to the reflective portions of the product. To generate the individual images for use in the animation, the gradient function is applied at different offset positions relative to the product image. U.S. Pat. No. 7,644,355 is useful in providing clear visual cues to assist the customer in recognizing the foil areas in a displayed product image and distinguishing those areas from the non-foil areas. Nonetheless, natural effects such as light scattering are not simulated and the areas representing the foil do not appear exactly as they would when implemented as a physical product.

U.S. patent application Ser. No. 12/911,521 filed Oct. 25, 2010, and published as US20120101790 on Apr. 26, 2012, hereby incorporated by reference in its entirety, discloses using photographic images to simulate the appearance of embroidery stitches in a rendered depiction of an embroidered design. U.S. patent application Ser. No. 12/911,521 does not application to a premium finish of a printed product nor of simulating the movement of light across the simulated image.

To minimize the risk of customer confusion and disappointment, it is highly desirable that the customer be shown an image of the product that is as accurate and natural a depiction of the physical product as possible. There is, therefore, a need for systems and methods for preparing product images for displaying on a user's computer display in a manner that indicates the location or locations in the product design of textured surfaces by simulating the effects of light on those materials and clearly distinguishes those regions from other regions of the product.

### SUMMARY

Customer previews are inserted into scene rendered animations to depict the customer's product at different lighting angles. In an embodiment, the scene rendered animations use real images (i.e., photographs) of real premium finishes (such as foil, spot gloss, vinyl, etc.) that will be used in the premium finished areas of the product, which serves to facilitate an accurate rendering and depict a natural appearance of the product as light moves across the product in an animated sequence. Because the appearance of the premium finish is both natural and accurate, the simulated depiction of the product gives the customer a more realistic expectation of how the final product will look, thereby improving customer satisfaction by matching customer expectations with the physical realities of the delivered product.

In an embodiment, a method for simulating the movement of light on a design to be applied to a product includes receiving a design image containing one or more primary regions which are to be finished using one or more primary finishes that are characterized by first light reflection characteristics and one or more secondary regions where a secondary finish is to be applied. A mask image indicating one or more regions of the product to be finished with the secondary finish is received, and a scene containing an image placeholder is identified. The identified scene is a description identifying at least one scene image, a description of a position of an image placeholder for placement of an injectable image, the scene description comprising instructions for generating a composite scene image having the injectable image embedded in the scene image. A first solid fill secondary finish photographic image taken at a first lighting angle is selected, and the selected solid fill secondary finish photographic image is composited, based on the received mask image, with the received design image to generate a composite image. The composite image is injected into the selected scene image according to the instructions of the scene description to generate an individual animation frame. If additional individual animations frames are required, a next secondary finish photographic image taken from a next lighting angle is selected, and additional individual frames are generated by repeating the compositing step and injecting step until a sufficient number of animation frames has been created. The individual animation frames are sent to a computer system, preferably in aggregated format, for sequential display on an electronic display.

### BRIEF DESCRIPTION OF THE DRAWINGS

FIG. 1 is a flowchart illustrating an exemplary method in accordance with an embodiment of the invention;

FIG. 2 is an example of a design image to be finished using a primary finish and a secondary finish;

FIG. 3 is an example of a mask image corresponding to the design image of FIG. 2;

FIG. 4 is an example of a scene image having a placeholder for injecting a design image;

FIG. 5 is a diagram illustrating the generation of individual image frames for use in generating an animated sequence;

FIG. 6 is an example of an individual composite scene image that may be used together with additional composite scene images to generate an animated sequence;

FIG. 7 shows an illustrative system with which the invention may be employed.

### DETAILED DESCRIPTION

It will be understood that, while the discussion herein describes an embodiment of the invention in the field of preparation of customized printed materials having premium finish regions such as foil, gloss, raised print, etc., it will be understood that the invention is not so limited and could be readily employed in any embodiment involving the presentation of an electronic image of any type of product wherein it is desired to indicate a texture that reflects light in a visually distinguishable from the base product texture.

Premium finishes are very difficult to visualize in a static context because their effect is dependent on how light bounces off the surface. In the present invention, scene rendered animations are implemented to depict the most accurate and natural-looking preview image of a user's design that contains one or more premium finish region. One technique involves compositing real imagery of foil taken from different angles to capture a range of light reflections. The use of real photographic images of actual foil (or other premium finish of interest) allows the capture of the subtle grain characteristics of the foil.

As is well known and understood in the art, color images displayed on computer monitors are comprised of many individual pixels with the displayed color of each individual pixel being the result of the combination of the three colors red, green and blue (RGB). Transparency is achieved through a separate channel (called the “alpha channel”) which includes a value that ranges between 0 and 100%, with 0 defining the pixel to be fully transparent to layers below it, and 100% defining the pixel to be 100 percent opaque (so that pixels on layers below are not visible). In a typical display system providing twenty-four bits of color information for each pixel (eight bits per color component), red, green and blue are each assigned an intensity value in the range from 0, representing no color, to 255, representing full intensity of that color. By varying these three intensity values, a large number of different colors can be represented. The transparency channel associated with each pixel is also provided with 8 bits, where alpha channel values that range between 0 (0%) and 255 (100%) result in a proportional blending of the pixel of the image with the visible pixels in the layers below it.

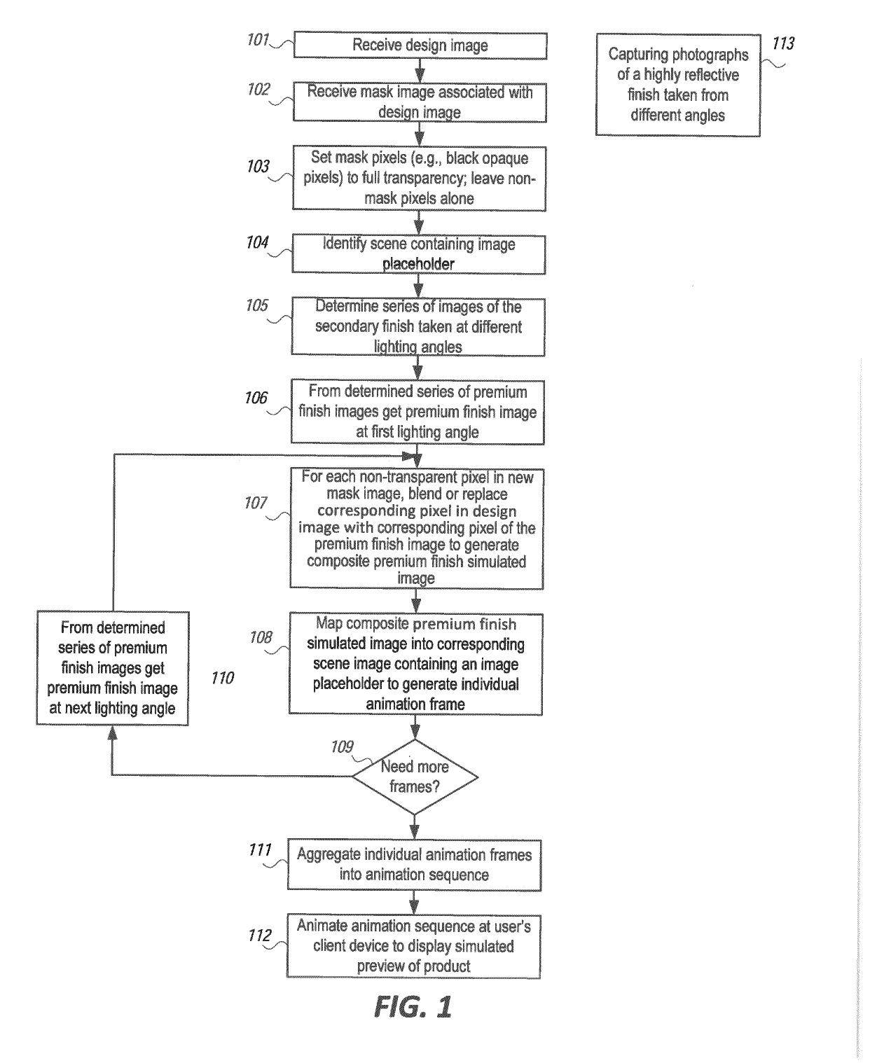

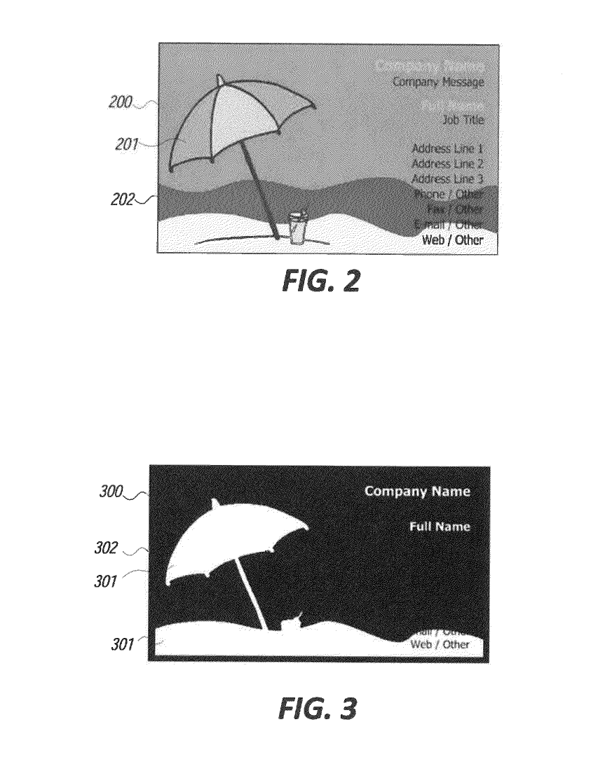

Turning now to FIG. 1, there is detailed therein a computerized method for simulating the movement of light over regions of a product that are to be finished with a material having reflective characteristics, and in particular regions of a product that have visually distinguishable (i.e., different) light reflection characteristics than the light reflection characteristics of the finish used for other regions of the product. In step 102, the system receives a design image containing primary regions which are to be finished using one or more primary finishes that are characterized by first light reflection characteristics. FIG. 2 shows an example design image 200 indicated for illustrative purposes. In an embodiment, the design image is a customized template containing text, imagery, fonts and colors, and which has been customized by a user to insert personalized information such as name, address, etc. In general all or a portion of the design image may be finished with a primary finish. For example, a printed business card may be printed with a design that includes both primary regions 202 to be finished with printed ink, and secondary regions 201 where a secondary finish is to be applied. The secondary regions may coincide with areas of the primary regions, or may be implemented only in areas where the primary finish is not to be applied. For example, for a business card that is to include printed and foiled regions, the foiled regions can be implemented only as foil, or may be foiled as the secondary finish and then include printed ink on top of the foil as the primary finish.

Returning to FIG. 1, in step 102 a mask image is received. The mask image indicates one or more regions of the product to be finished with a different (e.g., secondary) finish that reflects light differently than the primary finish. An example mask image 300 which corresponds to the design image 200 of FIG. 2 is shown in FIG. 3. The mask image 300 has region(s) 301 that correspond to areas of the design that are to be finished using the secondary finish and regions 302 that correspond to areas of the design that are not to be finished using the secondary finish. In an embodiment, the regions 301 indicating where the secondary finish is to be applied are implemented in the mask image 300 as white pixels which correspond to pixels where the secondary/premium finish is to be applied in the corresponding design. The remaining pixels are implemented as black pixels, corresponding to pixels in the corresponding design where no premium finish is to be applied. Both the design image 200 and the mask image 300 are preferably image files such as .jpg files, each are of the same dimensions, and each has the same number of pixels which correspond to one another.

Returning again to FIG. 1, in step 103, pixels corresponding to mask image regions 302 in the mask image 300 are set to full transparency. Pixels corresponding to the mask image regions 301 indicating where a secondary finish is to be applied are left alone (i.e., remain set to white fully opaque pixels). Thus, in an embodiment where the black pixels indicate areas of primary finish and white pixels indicate areas of secondary finish, the method includes converting all black pixels to transparent (alpha channel=0), leaving a mask image where white pixels indicate the secondary finish and every else is transparent.

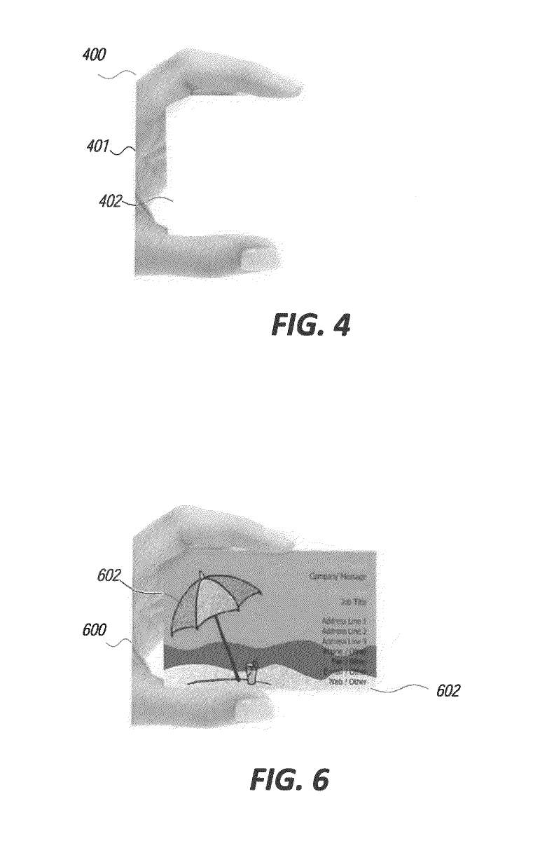

In step 104, a scene containing an image placeholder is identified. In an embodiment, the identified scene is a description identifying a .jpg image and a description of an image placeholder (i.e., the identification of the position of a to-be-inserted image) which is to be placed on a layer over the identified .jpg scene image. FIG. 4 illustrates an example scene image 400 containing a main image 401 and an image placeholder 402 where a second image is to be injected into the scene image 400 through resizing, warping and compositing the second image to match the size, shape and perspective of the placeholder 402.

In a preferred embodiment of a system implemented in accordance with the invention, the system includes a repository (e.g., a non-transitory computer readable memory) which contains a pool of different scene images into which the design can be inserted. In an embodiment, the pool of scene images can contain a number of images of an identical scene taken with different illumination source positions. Alternatively, the pool of scene images can contain a number of images of the same scene positioned at a different angle.

Returning again to FIG. 1, in step 105, the method includes determining a series of secondary finish images comprising the same size and shape as the design document where each secondary finish image in the series is taken at a different source illumination angle. In an embodiment, each image in the series of secondary finish images taken at different source illumination angles includes a photographic image the same size (dimensions) as the design image that is a full coverage specimen of the secondary finish.

In general, for each secondary finish offered, and for each set of allowed design dimensions offered (e.g., dimensions of business cards, greeting cards, brochures, etc.), a design of the corresponding dimensions having a solid fill of the respective secondary finish is created. The design specifying the solid fill secondary finish is physically created and photographs of the solid fill secondary finish design on the product, taken with the illumination by the source light at different angles, as indicated in step 113, are cataloged by source lighting angle and design dimensions, and stored. In general, different illuminations angles can be generated by either moving, relative to the source lighting, the physical product on which the design is implemented, or by fixing the product in place and physically moving the source lighting. In an embodiment, the images of the solid fill design of the secondary finish are stored in a computer-readable accessible database. Preferably, a photograph is taken of the solid fill design for every 1° relative movement between the physical design and the source light over a span of at least 35°.

In step 106, the method selects a first solid fill secondary finish photographic image taken at a first lighting angle. The, using the converted mask image generated in step 103, the method composites the selected solid fill secondary finish photographic image with the design image received in step 101. In step 107, for each non-transparent pixel in the converted mask image, the corresponding pixel of the selected solid fill secondary finish photographic image either replaces or is blended with the pixel in the received design image. The compositing can directly modify the received design image or can be saved into a newly created composite image. After all non-transparent pixels in the converted mask image have been processed, the result is a composite image that contains corresponding pixels of the selected solid fill secondary finish photographic image replacing or blended with the corresponding pixels of the design image where specified by the mask.

The composite image generated in step 108 is then injected into the selected scene image by mapping the composite image into the image placeholder in the scene image identified in step 104 to generate an individual animation frame.

For the animation, a check is made in step 109 as to whether a sufficient number of frames has been generated. If not, then in step 110 a next secondary finish photographic image taken from a next lighting angle is selected from the determined series of photographic images, and steps 107 through 109 are repeated until a sufficient number of animation frames has been created. If a sufficient number of animation frames has been generated, the frames are aggregated into an animation sequence in step 111. In step 112, the animation sequence is then played at the client device to display the design image while simulating the effect of the movement of light on the product at different lighting angles. In this regard, the sequence of individual frames is downloaded to the client device and repeatedly displayed in sequence at a rate preferably faster than the sampling rate of the human eye. In an embodiment, in step 111 after all of the individual frames have been created, they are composited into a single image called a Sprite sheet that is sent to the client device. Once the client device receives this image (sprite sheet), a JavaScript animation script animates the frames in the client web browser.

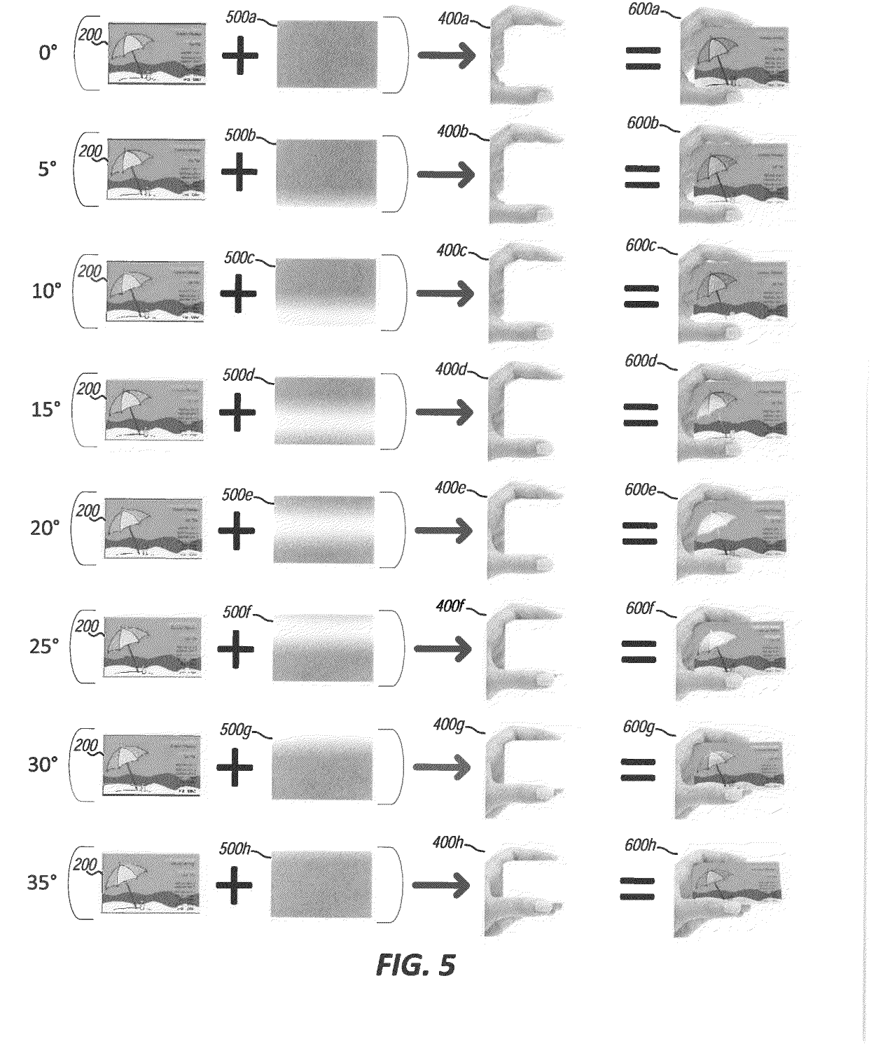

FIG. 5 diagrammatically illustrates the generation of an animated scene that simulates the movement of light over shiny areas of a printed product. In the example illustration, the shiny areas are areas of the printed product that are foiled. As illustrated in FIG. 5, the design image 200 and different foil images taken at lighting angles 0°, 5°, 10°, 15°, 20°, 25°, 30° and 35° are composited based on a corresponding mask image 300. Each composite image is then injected into a corresponding scene image, which in the illustrated embodiment changes the position of the placeholder image sequentially between 0° and 35°. In the illustration, the scene image is of a hand holding a blank card. Between 0° and 35°, the hand rotates the card by 35°. In this embodiment, the scene images are obtained by photographing the hand holding the blank business card and sequentially photographing the hand and card as one or the other of the camera or the hand itself rotates by 35°. The composite foil image associated with each lighting angle is injected into the corresponding scene image, as indicated in the last column of images of FIG. 5. When displayed in rapid sequence on a computer display, the hand and card held by the hand appear to rotate, and the light on the surface of the “foiled” areas appears to move based on the angle of rotation of the hand in the scene images. The coordination of the angles of the scene relative to the angle of lighting in the solid “foil” image improves the natural appearance of the light simulation.

Although FIG. 5 shows a scene that changes the position of the placeholder image across different angles 0° through 35°, the scene itself need not necessarily simulate movement of the scene content. For example, using a single scene image, for example, scene_img_{—}0°, one could still inject each of the composite images composite_{—}0°, composite_{—}5°, . . . , composite_{—}35° into the fixed scene, scene_img_{—}0°, to generate individual frames, and the animated sequence would show the non-moving scene, for example as shown in FIG. 6, with only the lighting source moving, resulting in a shimmering appearance of the “foiled” areas 602 of the card design.

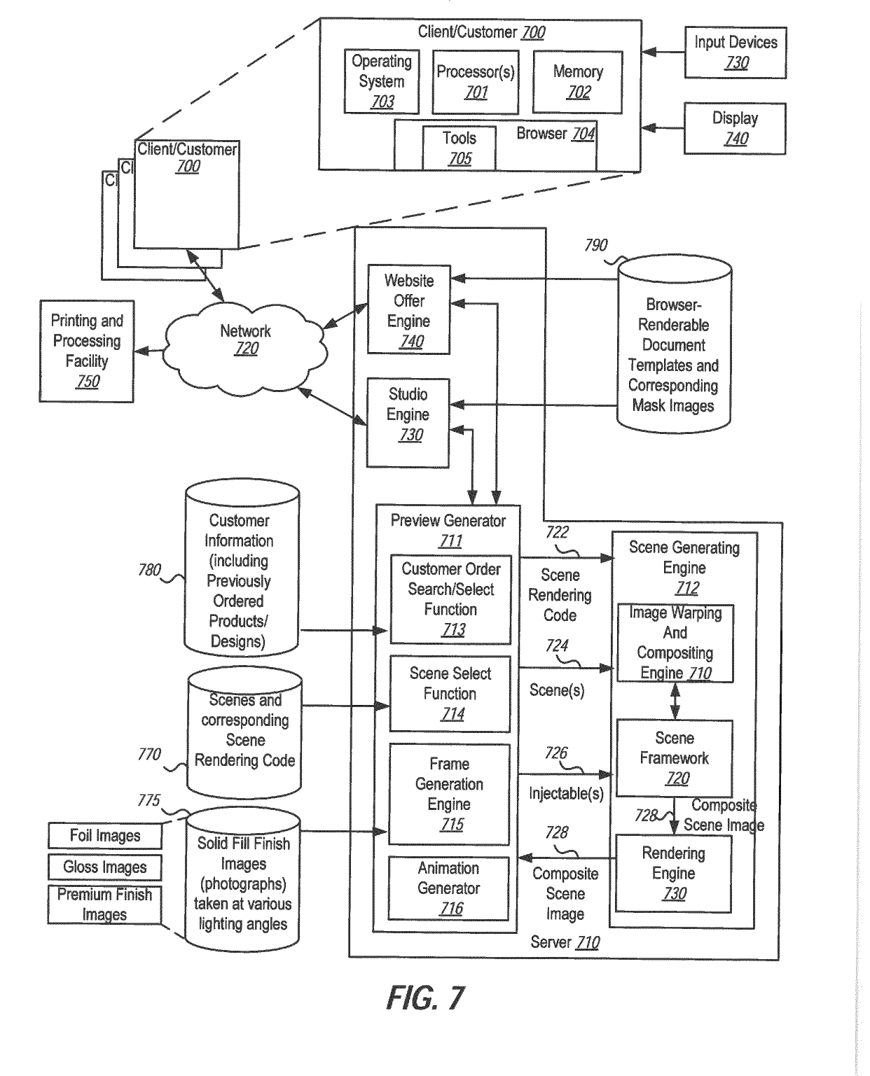

FIG. 7 depicts one illustrative system with which the invention may be employed. Customers' client computer systems 700 each includes processor(s) 701 and memory 702. Memory 702 represents all client computer system's 700 components and subsystems that provide data storage for the client computer system 700, such as RAM, ROM, and internal and external hard drives. In addition to providing permanent storage for all programs installed on client computer system 700, memory 702 also provides temporary storage required by the operating system 703 and any application program that may be executing. In the embodiment described herein, client computer system 700 is a typically equipped personal computer, but client computer system 700 could also be any other suitable device for interacting with server 710, such as a portable computer, a tablet computer, a data-enabled cellular phone or smartphone, or a computer system particularly adapted or provided for electronic product design, such as a product design kiosk, workstation or terminal. The user views images from client computer system 700 on display 740, such as a CRT or LCD screen, and provides inputs to client computer system 700 via input devices 710, such as a keyboard, a mouse, a touchscreen or any other user input device.

When client computer system 700 is operating, an instance of the client computer system operating system 703, for example a version of the Microsoft Windows operating system, Apple iOS, etc., will be running, represented in FIG. 7 by operating system 703. In FIG. 7, client computer system 700 is running a Web browser 704, such as, for example, Internet Explorer from Microsoft Corporation, Safari from Apple Corporation, or any other suitable Web browser. In the depicted embodiment, Tools 705 represents product design and ordering programs and tools downloaded to client computer system 700 via Network 720 from remote Server 710, such as downloadable product design and ordering tools provided at www.vistaprint.com. Tools 705 run in browser 704 and exchanges information and instructions with Server 710 during a design session to support the user's preparation of a customized product. When the customer is satisfied with the design of the product, the design can be uploaded to Server 710 for storage and subsequent production of the desired quantity of the physical product on appropriate printing and post-print processing systems at printing and processing facility 750. Facility 750 could be owned and operated by the operator of Server 710 or could be owned and operated by another party.

While Server 710 is shown in FIG. 7 as a single block, it will be understood that Server 710 could be multiple servers configured to communicate and operate cooperatively to support Web site operations. Server 710 will typically be interacting with many user computer systems, such as one or more different customer computer systems 700, simultaneously. Server 710 includes the components and subsystems that provide server data storage, such as RAM, ROM, and disk drives or arrays for retaining the various product layouts, designs, colors, fonts, and other information to enable the creation and rendering of electronic product designs.

In interacting with server 710 to create a custom product design, the user is typically presented with one or more screen displays (not shown) allowing the user to select a type of product for customization and then review thumbnail images of various product design templates prepared by the site operator and made available for customization by the user with the user's personal text or other content. To provide the customer with a wide range of styles and design choices, each product design template typically comprises a combination of graphics, images, fonts, color schemes, and/or other design elements. When a specific product template design is selected by the user for customization, the markup language elements and layout instructions needed for browser 704 to properly render the template at the user's computer are downloaded from server 720 to client computer system 700.

After (or even during) user customization, the server 710 may receive an electronic document describing a personalized product design of a customer. In an embodiment, the server 710 includes a Browser-Renderable Preview Generator 711 which includes a scene generating engine 712 and which generates a preview image of the personalized product design of the customer embedded within a larger scene image to give the customer an accurate representation of what the physical product will look like.

The scene generating engine 712 includes an image warping and compositing engine 710, a scene framework engine 720, and a rendering engine 730. The scene framework 720 receives or obtains a scene description (i.e., scene rendering code) 722, one or more scene image(s) 724, and one or more image(s)/text/document(s) (hereinafter called “injectable(s)”) 726 to place within a generated scene. The scene framework 720 generates a composite scene image 728 containing the injectable(s) 724 composited into the received scene(s) 724 according to the scene description 722. The scene description 722 is implemented using an intuitive language (for example, in an XML format), and specifies the warping and compositing functionality to be performed on the injectable(s) 726 and/or the scene(s) 724 when generating the composite image 728. A rendering engine 730 receives the composite image 728 and renders it in a user's browser.

The scene framework 720 is a graphical composition framework that allows injection of documents, images, text, logos, uploads, etc., into a scene (which may be generated by layering one or more images). All layers of the composite image may be independently warped, and additional layering, coloring, transparency, and other inter-layer functions are provided. The scene framework 720 includes an engine which executes, interprets, consumes, or otherwise processes the scene rendering code 722 using the specified scene(s) 722 and injectable(s) 724.

At a high level, the Framework 720 is a scene rendering technology for showing customized products in context. A generated preview of a customer's customized product may be transformed in various ways, and placed inside a larger scene. An example of such a preview image implemented in a contextual scene is illustrated in FIG. 6, showing a preview image of a customer's business card embedded in a scene image containing a hand holding the business card. In order to simulate the light moving over the foiled regions of the card, a sequence of such images 600a-600h are generated and displayed in rapid sequence on the customer's display screen to display an animated scene simulating light moving across the foiled regions of the customer's business card.

Upon receipt of an electronic document 200 implementing a personalized product design of a customer, the server 710 retrieves, generates, or selects a Scene Image and corresponding Scene Rendering Code. In the system of FIG. 7, the Preview Generator 711 includes a Scene Select Function 714 that searches a Scenes Database 770 for one or more scene images 724 and corresponding scene rendering code 722. In an exemplary embodiment, the Scene Select Function 714 selects a scene image 724 based on information extracted from retrieved customer information. For example, if the customer ordered a business card, the Scene Select Function 714 may search for scene images in which business cards would be relevant. The scene images 724 and corresponding scene rendering code 772 stored in the Scenes database 770 may be tagged with keywords. For example, some scenes may incorporate images of people exchanging a business card, or show an office with a desk on which a business card holder holding a business card is shown, etc. Such scenes could be tagged with the keyword phrase “business card” or “office” to indicate to the Scene Select Function 714 that such scene would be suited for injection of the preview image of the customer's personalized business card into the scene. Additional keyword tags, relevant to such aspects as a customer's zipcode, industry, etc. could also be associated with the scenes and used by the Scene Select Function 714 to identify scenes that are potentially relevant to the customer.

Given one or more selected Scene image(s) 724 and corresponding Scene Rendering Code 722, the Preview Generator 711 determines whether the customer's personalized design includes any premium finishes such as foil, gloss, vinyl, or other shiny textured finish and if so, triggers a frame generation engine 715 to generate a plurality of individual frames containing a preview image of the customer's design injected into a scene. Each frame contains a preview image of the customer's design with the secondary regions illuminated from different lighting angles. In an embodiment, the Frame generation engine 715 retrieves the mask image corresponding to the customer's design image, and further retrieves a plurality of solid fill secondary finish photographic images taken at different lighting angles. The Frame generation engine 715 composites each of the retrieved solid fill secondary finish photographic images with a rendered image of the customer's design based on the mask image (in accordance with the method discussed in connection with FIG. 1) to generate a plurality of individual composite images of the user's design. This plurality of individual composite images can be directly animated by the Animation Generator 716, which packages the individual images (i.e., individual animation frames) into a format usable by an animation player on the client computer system 100. In an embodiment, the Animation Generator 716 inserts the individual images into a Sprite Sheet, which is then sent to the client computer system and used by an animation player resident on the client computer system 700 to display an animated preview of the customer's design on the customer's display to display a simulation of a moving light source on the secondary regions of the customer's design. In an alternative embodiment, the plurality of individual composite images of the user's design composited with solid fill secondary finish images taken at different lighting angles are injected into at least one scene image to illustrate how the physical product will look when implemented and how the product will look relative to one or more additional items. For example, the size of a product can be illustrated by placing the simulated display version of the product into a scene image containing other items that the customer will be familiar with so that the customer can judge how large the physical product will be. In this embodiment, the frame generation engine 715 triggers the scene generation engine 712 to inject each of the composited images into a scene to generate individual frames for an animated scene.

The animation generator 716 receives all of the individual frames and sequences them into an animated sequence. The animation generator 716 may further package the sequenced frames into an animation image, for example a Sprite Sheet, which is sent to the customer's computer system 700, where it is unpackaged and displayed in sequence to display the animated sequence of the customer's design with simulated light movement.

Example scene rendering code implementing a scene description for the first frame 600a of the animation sequence shown in FIG. 5 is as follows:

```
<?xml version=“1.0” encoding=“utf-8”?>
<Dip xmlns:xsd=“http://www.w3.org/2001/XMLSchema”
xmlns:xsi=“http://www.w3.org/2001/XMLSchema-instance” version=“1”>
<Transforms>
  <PerspectiveWarp size=“500,400” id=“cardWarp”>
    <MapPoint source=“0.016,0.029” target=“51.16233,81” />
    <MapPoint source=“0.984,0.029” target=“427.849,82.19001” />
    <MapPoint source=“0.016,0.971” target=“56.35859,329.4787” />
    <MapPoint source=“0.984,0.971” target=“429.3471,329.8084” />
  </PerspectiveWarp>
</Transforms>
<Composite size=“500,400” mode=“normal” depth=“0”>
  <Image mode=“normal” depth=“99” src=“../../../images/blanks/eu/0.png” />
    <Composite size=“500,400” mode=“multiply” depth=“0”>
      <Image mode=“normal” depth=“3” xform=“cardWarp” src=“../../../images/foil/0.png” />
      <Document size=“463,300” mode=“mask” depth=“2” xform=“cardWarp” index=“0” page=“1”
      offset=“0” channel=“foil” />
      <Document size=“463,300” mode=“overlay” depth=“1” xform=“cardWarp” index=“0”
      page=“1” offset=“0” />
      <Image mode=“mask” depth=“0” src=“../../../images/masks/eu/0.png” />
    </Composite>
</Composite>
</Dip>
```

The above scene rendering code is implemented using XML (eXtended Markup Language). The scene rendering code defines a perspective warp transformation called “cardWarp” which takes as input the corner coordinates of a source image (normalized to range from 0 to 1, where coordinates (0, 0) correspond to an upper left corner of a rectangular image, and (1, 1) corresponds to a lower right corner of the rectangular image. The perspective warp transformation maps the input source points to target points (defined in terms of actual pixel locations (which in this example is 500 by 400 pixels).

The first step in creating the final composite is to draw the image of the hand holding the blank card (located at src=“../../../images/blanks/eu/0.png”) to the canvas. Next, a nested composite is created to hold the document (business card) and its foil mask. The foil image (located at src=“../../../images/foil/0.png) is blended into the document according to the white areas in the foil mask. The result of this blending is now mapped back into the blank card image using the “cardWarp” transformation in a multiply mode. Finally, another mask image (located at “../../../images/masks/eu/0,png”) is used to remove areas where the blended document is overlapping the fingers in the hand image.

What is claimed is:

1. A method for simulating the movement of light on a design to be applied to a product, comprising:
receiving a design image containing one or more primary regions which are to be finished using one or more primary finishes that are characterized by first light reflection characteristics and one or more secondary regions where a secondary finish is to be applied;
receiving a mask image, the mask image indicating one or more regions of the product to be finished with the secondary finish;
identifying a scene containing an image placeholder, wherein the identified scene is a description identifying at least one scene image, a description of a position of an image placeholder for placement of an injectable image, the scene description comprising instructions for generating a composite scene image having the injectable image embedded in the scene image;
selecting a first solid fill secondary finish photographic image taken at a first lighting angle;
compositing, based on the mask image, the selected solid fill secondary finish photographic image with the received design image to generate a composite image;
injecting the composite image into the selected scene image according to the instructions of the scene description to generate an individual animation frame;
if additional individual animations frames are required, selecting a next secondary finish photographic image taken from a next lighting angle and repeating the compositing step and injecting step until a sufficient number of animation frames has been created; and
aggregating the individual animation frames into an animation sequence.

2. The method of claim 1, further comprising sending the animation sequence to a browser of a computer system for displaying the animation sequence on the display of the computer system.

3. The method of claim 1, wherein one or more secondary regions at least partially coincides with one or more areas of the primary regions.

4. The method of claim 1, wherein the one or more secondary regions are mutually exclusive of the primary regions.

5. The method of claim 1, wherein the secondary finish is characterized to reflect light differently than light reflecting from the primary finish.

6. The method of claim 1, wherein the mask image is preprocessed by setting pixels corresponding to mask image regions in the mask image to full transparency and setting pixels corresponding to the mask image regions indicating where a secondary finish is to be applied are set to a predetermined non-transparent pixel value.

7. The method of claim 1, wherein the scene description includes instructions for warping the injectable image to match the size and shape of the image placeholder.

8. The method of claim 1, wherein the scene description includes instructions for layering the at least one scene image and the injectable image.

9. The method of claim 1, wherein each of the secondary finish images comprises a photographic image having the same dimensions as the design image and comprising a solid fill of the secondary finish.

10. The method of claim 1, wherein for each respective non-transparent pixel in the converted mask image, replacing the corresponding pixel of the selected solid fill secondary finish photographic image with the corresponding pixel in the received design image to generate the composite image.

11. The method of claim 1, wherein for each respective non-transparent pixel in the converted mask image, blending the corresponding pixel of the selected solid fill secondary finish photographic image with the corresponding pixel in the received design image to generate the composite image.

12. A system for generating a computer-renderable animation simulating the movement of light on a design to be applied to a product, comprising:
one or more processors configured to receive a design image containing one or more primary regions which are to be finished using one or more primary finishes that are characterized by first light reflection characteristics and one or more secondary regions where a secondary finish is to be applied;
one or more processors configured to receive a mask image, the mask image indicating one or more regions of the product to be finished with the secondary finish;
one or more processors configured to identify a scene containing an image placeholder, wherein the identified scene is a description identifying at least one scene image, a description of a position of an image placeholder for placement of an injectable image, the scene description comprising instructions for generating a composite scene image having the injectable image embedded in the scene image;
one or more processors configured to select a first solid fill secondary finish photographic image taken at a first lighting angle;
one or more processors configured to composite, based on the mask image, the selected solid fill secondary finish photographic image with the received design image to generate a composite image;
one or more processors configured to inject the composite image into the selected scene image according to the instructions of the scene description to generate an individual animation frame;
one or more processors configured to, if additional individual animations frames are required, select a next secondary finish photographic image taken from a next lighting angle and repeating the compositing step and injecting step until a sufficient number of animation frames has been created; and
one or more processors configured to aggregate the individual animation frames into an animation sequence.

13. The system of claim 1, further comprising one or more processors configured to send the animation sequence to a browser of a computer system for displaying the animation sequence on the display of the computer system.

14. The system of claim 1, wherein one or more secondary regions at least partially coincides with one or more areas of the primary regions.

15. The system of claim 1, wherein the one or more secondary regions are mutually exclusive of the primary regions.

16. The system of claim 1, wherein the secondary finish is characterized to reflect light differently than light reflecting from the primary finish.

17. The system of claim 1, further comprising one or more processors configured to preprocess the mask image by setting pixels corresponding to mask image regions in the mask image to full transparency and setting pixels corresponding to the mask image regions indicating where a secondary finish is to be applied are set to a predetermined non-transparent pixel value.

18. The system of claim 1, wherein the scene description includes instructions for warping the injectable image to match the size and shape of the image placeholder.

19. The system of claim 1, wherein the scene description includes instructions for layering the at least one scene image and the injectable image.

20. The system of claim 1, wherein each of the secondary finish images comprises a photographic image having the same dimensions as the design image and comprising a solid fill of the secondary finish.

21. The system of claim 1, further comprising one or more processors configured to, for each respective non-transparent pixel in the converted mask image, replace the corresponding pixel of the selected solid fill secondary finish photographic image with the corresponding pixel in the received design image to generate the composite image.

22. The system of claim 1, further comprising one or more processors configured to, for each respective non-transparent pixel in the converted mask image, blend the corresponding pixel of the selected solid fill secondary finish photographic image with the corresponding pixel in the received design image to generate the composite image.
